(19) United States
(12) Patent Application Publication
(10) Pub. No.: US 2008/0233389 A1
(43) Pub. Date: Sep. 25, 2008

(54) OPTICAL RECORDING MEDIUM AND ITS MANUFACTURING METHOD

(75) Inventors: Takemitsu Sakai, Miyagi (JP); Yuichi Sabi, Tokyo (JP); Etsuro Ikeda, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/049,888

(22) Filed: Mar. 17, 2008

(30) Foreign Application Priority Data
Mar. 23, 2007 (JP) 2007-077961

(51) Int. Cl. G11B 7/24

(52) U.S. Cl. 428/336; 428/701; 427/404

(57) ABSTRACT

An optical recording medium having an inorganic recording film, wherein the inorganic recording film has: a first recording film containing titanium Ti; and a second recording film containing oxides of germanium Ge and tin Sn.

### CROSS REFERENCES TO RELATED APPLICATIONS

The present invention contains subject matter related to Japanese Patent Application JP 2007-077961 filed in the Japanese Patent Office on Mar. 23, 2007, the entire contents of which being incorporated herein by reference.

### BACKGROUND OF THE INVENTION

1. Field of the Invention

The invention relates to an optical recording medium and its manufacturing method and, more particularly, to an optical recording medium having an inorganic recording film.

2. Description of the Related Arts

In recent years, an optical recording medium of a high density recording which can record information of a large capacity has been demanded. For example, to satisfy such a request, a standard of a Blu-ray Disc (registered trademark: hereinbelow, referred to as a BD) has been decided and a high-definition image can be recorded and stored in the optical recording medium. Assuming that a normal reproducing speed of the high-definition image is set to a 1-time speed, according to the standard ver.1.1 of BD-R (Blu-ray Disc-Recordable), the BD has already coped with the recording of up to 2-times speed.

As an optical recording medium which can cope with such a standard, for example, a disc having an inorganic recording film constructed by a first recording film containing titanium Ti and a second recording film containing an oxide of germanium Ge has been proposed (for example, refer to Patent Document 1: JP-A-2006-281751). Such an optical recording medium is constructed by a small number of layers such as four layer films and also has a wide power margin and very high durability although it is constructed by four layer films.

### SUMMARY OF THE INVENTION

However, in such an optical recording medium, there is such a problem that when an ultraviolet hardening resin (hereinbelow, referred to as a UV resin) is used as a light transmitting layer having a thickness of 0.1 mm, the durability deteriorates. It is considered that such a problem is caused by the following reasons. Since a number of micro cracks are caused from a portion deformed by the recording as a start point by contraction or the like of the UV resin forming the light transmitting layer, moisture in the atmosphere enters from the cracks and germanium Ge is diffused or aggregated in the portion having the moisture. When germanium Ge in the inorganic recording film is diffused or aggregated, the deterioration of the inorganic recording film progresses.

It is, therefore, desirable to provide an optical recording medium whose durability can be improved and its manufacturing method.

The present inventors et al. have vigorously examined in order to improve the durability of the optical recording medium having the inorganic recording film. Thus, they have found out that the durability can be improved by adding tin Sn as an additive into a second recording film containing an oxide of germanium Ge, and the invention has been completed.

According to an embodiment of the present invention, there is provided an optical recording medium having an inorganic recording film, wherein the inorganic recording film has: a first recording film containing titanium Ti; and a second recording film containing oxides of germanium Ge and tin Sn.

According to another embodiment of the present invention, there is provided a manufacturing method of an optical recording medium having an inorganic recording film, comprising the steps of: forming a first recording film containing titanium Ti; and forming a second recording film containing oxides of germanium Ge and tin Sn.

According to the embodiments of the invention, when recording light is irradiated, oxygen contained in the second recording film is separated and a Ge layer whose oxygen content is large is formed in an interface with the second recording film. That is, the second recording film is separated into two stable layers in which optical constants are different and storage stability is high. Thus, when reproducing light is irradiated, since a reflection light amount of a portion where the recording light was irradiated and that of a portion where the recording light is not irradiated change, good signal characteristics are obtained. According to the first recording film, there is hardly a change between physical characteristics before the recording and those after the recording and what is called a catalytic operation which promotes a reaction at the interface with the second recording film is caused.

As described above, according to the embodiments of the invention, since the second recording film contains the oxides of germanium Ge and tin Sn, the durability of the optical recording medium can be improved.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic cross sectional view showing a constructional example of an optical recording medium according to the first embodiment of the invention;

FIG. 2 is a schematic cross sectional view showing a constructional example of an optical recording medium according to the second embodiment of the invention;

FIG. 3 is a schematic cross sectional view showing a constructional example of an optical recording medium according to the third embodiment of the invention;

FIG. 4 is a graph showing relations among an Sn content, a recording sensitivity Pwo, and a power margin in each of Comparison 1-1 and Examples 1-1 to 1-6;

FIG. 5 is a graph showing a relation between the Sn content and an amplitude value R8H*I2pp/I8H of a 2T signal in each of Comparison 1-1 and Examples 1-1 to 1-6;

FIG. 6 is a graph showing a relation between a thickness of SnO₂ film and a power margin in each of Examples 2-1 to 2-6; and

FIG. 7 is a graph showing a relation between a thickness of SnO₂ film and a power margin in each of Examples 3-1 to 3-6.

### DETAILED DESCRIPTION OF THE PREFERRED EMBODIMENTS

Embodiments of the invention will be described hereinbelow with reference to the drawings.

### (1) First Embodiment

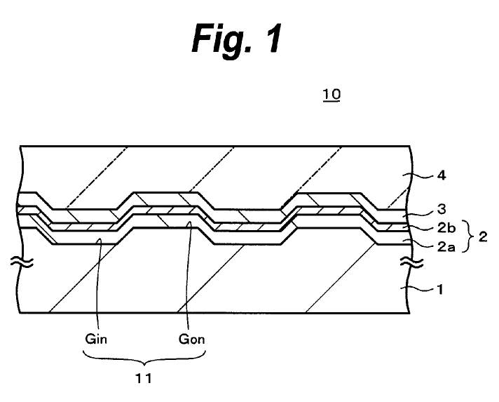

Construction of optical recording medium FIG. 1 is a schematic cross sectional view showing a constructional example of an optical recording medium according to the first embodiment of the invention. This optical recording medium 10 is what is called a WORM (write once) type optical recording medium and has a construction in which an inorganic recording film 2, a dielectric film 3, and a light transmitting layer 4 are sequentially laminated onto a substrate 1.

In the optical recording medium 10 according to the first embodiment, an information signal is recorded or reproduced by irradiating a laser beam from the light transmitting layer 4 side onto the inorganic recording film 2. For example, the laser beam having a wavelength within a range from 400 nm or more to 410 nm or less is converged by an objective lens having a numerical aperture within a range from 0.84 or more to 0.86 or less and is irradiated from the light transmitting layer 4 side onto the inorganic recording film 2, thereby recording or reproducing the information signal. For example, a BD-R can be mentioned as such an optical recording medium 10.

The substrate 1, inorganic recording film 2, dielectric film 3, and light transmitting layer 4 constructing the optical recording medium 10 will be sequentially described hereinbelow.

### (Substrate)

The substrate 1 has a ring shape in which an opening (hereinbelow, referred to as a center hole) has been formed at the center. One principal plane of the substrate 1 is a concave/convex surface 11. The inorganic recording film 2 is formed on the concave/convex surface 11. A concave portion of the concave/convex surface 11 is called an in-groove Gin and a convex portion is called an on-groove Gon.

As a shape of each of the in-groove Gin and the on-groove Gon, for example, various shapes such as spiral shape, concentric shape, and the like can be mentioned. The in-groove Gin and/or the on-groove Gon are/is wobbled in order to add, for example, address information.

A diameter of substrate 1 is selected to, for example, 120 mm. A thickness of substrate 1 is selected in consideration of rigidity and is selected to, preferably, 0.3 to 1.3 mm, much preferably, 0.6 to 1.3 mm, for example, 1.1 mm. A diameter of center hole is selected to, for example, 15 mm.

As a material of the substrate 1, for example, a plastics material or glass can be used. It is preferable to use the plastics material from a viewpoint of costs. As a plastics material, for example, a polycarbonate system resin, a polyolefin system resin, an acrylic resin, or the like can be used.

### (Inorganic Recording Film)

The inorganic recording film 2 is formed by a first recording film 2a and a second recording film 2b which are sequentially laminated on the concave/convex surface 11 of the substrate 1. The first recording film 2a is provided on the concave/convex surface 11 side of the substrate 1 and the second recording film 2b is provided on the dielectric film 3 side.

The first recording film 2a contains titanium Ti as a main component. It is preferable that the first recording film 2a contains a low thermal conductive metal such as manganese Mn, zirconium Zr, hafnium Hf, or the like as an additive from a viewpoint of improvement of a power margin. A content of the low thermal conductive metal is equal to, preferably, 1 to 40 atom %, much preferably, 2 to 30 atom %, and further preferably, 5 to 28 atom %. It is also preferable that the first recording film 2a contains a small amount of nitrogen N from a viewpoint of adjustment of recording sensitivity. A thickness of first recording film 2a is equal to, preferably, 10 to 50 nm.

The second recording film 2b contains an oxide of germanium Ge as a main component. A content of the oxide of germanium Ge in the second recording film 2b is equal to, preferably, 88 to 97 atom %, much preferably, 90 to 97 atom %, and further preferably, 90 to 95 atom %. The second recording film 2b contains tin Sn as an additive from a viewpoint of improvement of durability. A content of tin Sn in the second recording film 2b is equal to, preferably, 3 to 12 atom %, much preferably, 3 to 10 atom %, and further preferably, 5 to 10 atom %. This is because if it is equal to 3 atom % or more, the excellent durability can be obtained and if it is equal to 12 atom % or less, excellent signal characteristics can be obtained. If the first recording film 2a contains titanium Ti as a main component and the second recording film 2b contains the oxide of germanium Ge as a main component, the good recording characteristics can be fundamentally obtained.

An absorption coefficient k of the second recording film 2b is equal to a value within, preferably, a range from 0.15 or more to 0.90 or less, much preferably, a range from 0.20 or more to 0.70 or less, and further preferably, a range from 0.25 or more to 0.60 or less from a viewpoint of improvement of a modulation degree and a carrier-to-noise ratio (hereinbelow, referred to as a C/N ratio), or the like. A thickness of second recording film 2b is equal to, preferably, 10 to 35 nm.

The absorption coefficient k in the specification is measured at a wavelength of 410 nm. The absorption coefficient k can be obtained as follows by using an ellipsometer (made by Rudolph Co., Ltd., trade name: Auto EL-462P17). A tangent Ψ which is obtained from an phase angle Δ of elliptic polarization light and an amplitude-intensity ratio of an ellipse is measured by the ellipsometer. A complex refractive index N and the absorption coefficient k can be obtained from the film thickness obtained by a surface profiler (made by Tencor Co., Ltd., trade name: P15). According to attached analyzing software of the commercially available ellipsometer, such work is executed by using a method of least squares or the like.

### (Dielectric Film)

The dielectric film 3 is provided in contact with the inorganic recording film 2 and is used to make an optical and mechanical protection of the inorganic recording film 2, that is, improvement of the durability, suppression of a deformation, that is, a swelling of the inorganic recording film 2 upon recording, and the like. As a material of the dielectric film 3, for example, SiN, ZnS—SiO₂, AlN, Al₂O₃, SiO₂, SiO₂—Cr₂O₃—ZrO₂ (hereinbelow, referred to as SCZ), or the like can be used and it is preferable to use ZnS—SiO₂. This is because an S/N ratio of the recording signal can be improved and the good signal characteristics can be obtained. A thickness of dielectric film 3 lies within a range, preferably, from 10 to 100 nm.

### (Light Transmitting Layer)

The light transmitting layer 4 is a light transmitting layer 4 of, for example, a resin coating type or a sheet adhering type. In this instance, the light transmitting layer 4 of the resin coating type indicates the light transmitting layer 4 formed by a resin coating method. The light transmitting layer 4 of the sheet adhering type indicates the light transmitting layer 4 formed by a sheet adhering method. The resin coating method and the sheet adhering method will be described hereinlater.

A thickness of light transmitting layer 4 is selected from a range, preferably, from 10 to 177 μm and selected to, for example, 100 μm. By combining such a thin light transmitting layer 4 with the objective lens having a high NA (numerical aperture) of, for example, about 0.85, the high density recording can be realized. An inner diameter (diameter) of light transmitting layer 4 is selected to, for example, 22.7 mm.

The light transmitting layer 4 of the resin coating type is a resin cover formed by hardening a photosensitive resin such as a UV resin or the like. The light transmitting layer of the sheet adhering type is formed by, for example, a light transmitting sheet (film) having a ring shape and an adhesive layer to adhere the light transmitting sheet to the substrate 1. The adhesive layer is made of, for example, a UV resin or a pressure sensitive adhesive (hereinbelow, referred to as a PSA).

It is preferable that each of the light transmitting sheet and the resin cover is made of a material whose absorbing performance to the laser beam which is used for recording and reproducing is low. Specifically speaking, it is preferable that each of the light transmitting sheet and the resin cover is made of a material whose transmittance is equal to 90% or more. As a material of the light transmitting sheet, for example, a polycarbonate resin, a polyolefin system resin (for example, Zeonex (registered trademark)), or the like can be mentioned. As a material of the resin cover, for example, an acrylic resin of an ultraviolet hardening type can be mentioned. A thickness of light transmitting sheet is selected to, preferably, 0.3 mm or less and, much preferably, is selected from a range from 3 to 177 μm.

As mentioned above, in the optical recording medium 10 in which the first recording film 2a containing titanium Ti and the second recording film 2b containing the oxide of germanium Ge are provided as an inorganic recording film 2, it is a recording mechanism that the second recording film 2b is separated into two layers whose oxygen contents are different upon recording. Since the first recording film 2a and the second recording film 2b are neighboring, such a separation of the second recording film 2b occurs. The surface of the first recording film 2a plays an important role for the oxygen separation. It is considered that it is a recording principle that a Ti oxide in the surface of the first recording film 2a absorbs the blue light and the like as recording light and a photocatalyst effect is obtained. Such a recording principle is indirectly verified because there is obtained such an experiment result that in the case where a material containing no titanium Ti, for example, an alloy containing aluminum Al or silver Ag as a main component is used or an inactive insulating dielectric film such as SiN, ZnS—SiO₂, or the like of merely a few nm is formed between the first recording film 2a and the second recording film 2b, the second recording film 2b is not clearly separated and a modulation degree decreases extremely.

Since such a recording mechanism is used, the addition of the additive to the second recording film 2b exerts a large influence on the separation of germanium Ge and oxygen O. Since the photocatalyst effect changes due to the addition of the additive to the first recording film 2a, the addition of the additive to the first recording film 2a exerts a large influence on the recording characteristics. Further, as will be explained hereinafter, by forming a transparent conductive film so as to be adjacent to one of the principal planes of the second recording film 2b, an influence is exerted on the recording characteristics such as a power margin and the like.

### Manufacturing Method of Optical Recording Medium

An example of a manufacturing method of an optical recording medium according to the first embodiment of the invention will now be described.

### (Forming Step of Substrate)

First, the substrate 1 in which the concave/convex surface 11 has been formed on one principal plane is molded. As a method of molding the substrate 1, for example, an injection molding (injection) method, a photopolymer method (2P method: Photo Polymerization), or the like can be used.

### (Film Forming Step of First Recording Film)

Subsequently, the substrate 1 is conveyed into a vacuum chamber in which, for example, a target containing Ti as a main component has been set and the inside of the vacuum chamber is evacuated until its pressure becomes a predetermined pressure. After that, while a processing gas is introduced into the vacuum chamber, the target is sputtered and the first recording film 2a is formed onto the substrate 1.

An example of film forming conditions in the film forming step is shown below.

Ultimate vacuum degree: 5.0×10⁻⁵ Pa

Atmosphere: 0.1 to 0.6 Pa

Applied electric power: 1 to 3 kW

Gas kind: Ar gas and N₂ gas

Flow rate of Ar gas: 10 to 40 sccm

Flow rate of N₂ gas: 1 to 10 sccm

### (Film Forming Step of Second Recording Film)

Subsequently, the substrate 1 is conveyed into a vacuum chamber in which, for example, a target made of germanium Ge and a target containing tin Sn have been set and the inside of the vacuum chamber is evacuated until its pressure becomes a predetermined pressure. After that, while the processing gas is introduced into the vacuum chamber, the targets are sputtered and the second recording film 2b is formed onto the first recording film 2a.

An example of film forming conditions in the film forming step is shown below.

Ultimate vacuum degree: 5.0×10⁻⁵ Pa

Atmosphere: 0.1 to 0.6 Pa

Applied electric power: 1 to 3 kW

Gas kind: Ar gas and O₂ gas

Flow rate of Ar gas: 24 sccm

Flow rate of O₂ gas: 9 sccm

### (Film Forming Step of Dielectric Film)

Subsequently, the substrate 1 is conveyed into a vacuum chamber in which, for example, a target made of ZnS—SiO₂ has been set and the inside of the vacuum chamber is evacuated until its pressure becomes a predetermined pressure. After that, while the processing gas is introduced into the vacuum chamber, the target is sputtered and the dielectric film 3 is formed onto the second recording film 2b.

An example of film forming conditions in the film forming step is shown below.

Ultimate vacuum degree: 5.0×10⁻⁵ Pa

Atmosphere: 0.1 to 0.6 Pa

Applied electric power: 1 to 4 kW

Gas kind: Ar gas

Flow rate of Ar gas: 6 sccm

### (Forming Step of Light Transmitting Layer)

Subsequently, the light transmitting layer 4 is formed onto the dielectric film 3. For example, the resin coating method, sheet adhering method, or the like can be used as a forming method of the light transmitting layer 4. The resin coating method is preferable from a viewpoint of reduction of the costs. According to the resin coating method, the surface of the dielectric film 3 is spin-coated with a photosensitive resin such as a UV resin or the like and light such as UV light or the like is irradiated to the photosensitive resin, thereby forming the light transmitting layer 4 as a resin cover. According to the sheet adhering method, a light transmitting sheet is adhered to the concave/convex surface 11 side on the substrate 1 by using an adhesive, thereby forming the light transmitting layer 4.

For example, a sheet resin adhering method, a sheet PSA adhering method, or the like can be used as a sheet adhering method. According to the sheet resin adhering method, the light transmitting sheet is adhered to the concave/convex surface 11 side on the substrate 1 by using the photosensitive resin such as a UV resin or the like coated on the dielectric film 3, thereby forming the light transmitting layer 4. According to the sheet PSA adhering method, the light transmitting sheet is adhered to the concave/convex surface 11 side on the substrate 1 by using the pressure sensitive adhesive PSA which has previously and uniformly been coated on one principal plane of such a sheet, thereby forming the light transmitting layer 4.

The optical recording medium 10 shown in FIG. 1 is obtained by the foregoing steps.

As mentioned above, according to the first embodiment of the invention, since the second recording film 2b contains tin Sn, the durability of the optical recording medium 10 having the light transmitting layer 4 of the resin coating type or the sheet adhering type, particularly, the durability of the optical recording medium 10 having the light transmitting layer 4 of the resin coating type can be improved.

Since the optical recording medium 10 can be formed merely by sequentially laminating the first recording film 2a, second recording film 2b, dielectric film 3, and light transmitting layer 4 onto the substrate 1, the optical recording medium 10 of the high recording density having the simple film structure can be realized. That is, the reasonable optical recording medium 10 of the high recording density can be provided.

### (2) Second Embodiment

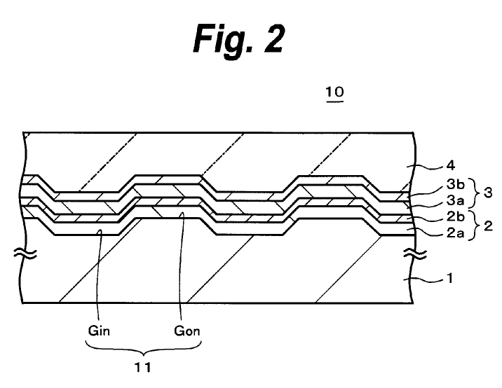

FIG. 2 is a schematic cross sectional view showing a constructional example of an optical recording medium according to the second embodiment of the invention. According to the second embodiment, the dielectric film 3 in the foregoing first embodiment is constructed by a first dielectric film 3a and a second dielectric film 3b. Portions similar to those in the foregoing first embodiment are designated by the same reference numerals and their explanation is omitted here.

The first dielectric film 3a is provided on the inorganic recording film 2 side. The second dielectric film 3b is provided on the light transmitting layer 4 side. The first dielectric film 3a and the second dielectric film 3b are made of dielectric substances of, for example, different materials and/or compositions.

As a material of the first dielectric film 3a, it is preferable to use ZnS—SiO₂ from a viewpoint of a film forming speed or the like. A thickness of first dielectric film 3a is equal to, for example, 10 to 100 nm. As a material of the second dielectric film 3b, it is preferable to use a stable dielectric substance such as SiN, SCZ, or the like from a viewpoint of suppression of a deterioration in light transmitting layer 4 or the like. If such as table dielectric substance is used, in the case of using the light transmitting layer of the adhering type as a light transmitting layer 4, a component such as sulfur S or the like contained in the first dielectric film 3a reacts with the PSA or the like of the light transmitting layer 4, the light transmitting layer 4 deteriorates, and the deterioration in durability can be suppressed. In the case of using the light transmitting layer of the resin coating type as a light transmitting layer 4, the deterioration in durability that is caused by a contraction upon hardening of the resin can be suppressed. A thickness of second dielectric film 3b lies within a range of, for example, 1 to 10 nm.

Subsequently, an example of a manufacturing method of the optical recording medium according to the second embodiment of the invention will be described. This manufacturing method of the optical recording medium has film forming steps of the first dielectric film and the second dielectric film in place of the film forming step of the dielectric film in the foregoing first embodiment.

An example of the film forming conditions of the first dielectric film and the second dielectric film will be explained hereinbelow.

### (Film Forming Step of First Dielectric Film)

The substrate 1 is conveyed into the vacuum chamber in which, for example, a target made of ZnS—SiO₂ has been set and the inside of the vacuum chamber is evacuated until its pressure becomes a predetermined pressure. After that, while a processing gas is introduced into the vacuum chamber, the target is sputtered and the first dielectric film 3a is formed onto the second recording film 2b.

An example of film forming conditions in the film forming step is shown below.

Ultimate vacuum degree: 5.0×10⁻⁵ Pa

Atmosphere: 0.1 to 0.6 Pa

Applied electric power: 1 to 4 kW

Gas kind: Ar gas

Flow rate of Ar gas: 6 sccm

### (Film Forming Step of Second Dielectric Film)

Subsequently, the substrate 1 is conveyed into the vacuum chamber in which, for example, a target made of SCZ has been set and the inside of the vacuum chamber is evacuated until its pressure becomes a predetermined pressure. After that, while a processing gas is introduced into the vacuum chamber, the target is sputtered and the second dielectric film 3b is formed onto the first dielectric film 3a.

An example of film forming conditions in the film forming step is shown below.

Ultimate vacuum degree: 5.0×10⁻⁵ Pa

Atmosphere: 0.1 to 0.6 Pa

Applied electric power: 1 to 3 kW

Gas kind: Ar gas

Flow rate of Ar gas: 15 sccm

As mentioned above, according to the second embodiment of the invention, since tin Sn is added to the second recording film 2b and the dielectric film 3 is constructed by the first dielectric film 3a and the second dielectric film 3b, the durability can be further improved as compared with that in the first embodiment.

### (3) Third Embodiment

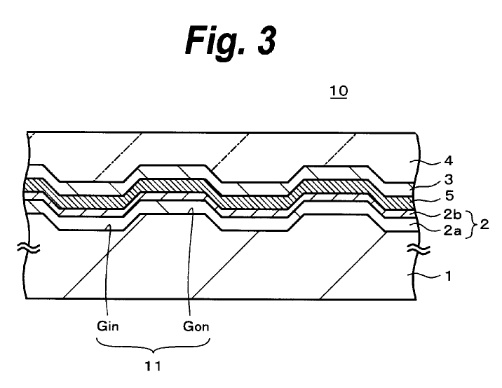

FIG. 3 is a schematic cross sectional view showing a constructional example of an optical recording medium according to the third embodiment of the invention. The third embodiment has a transparent conductive film 5 between the inorganic recording film 2 and the dielectric film 3. Portions similar to those in the foregoing first embodiment are designated by the same reference numerals and their explanation is omitted here. It is preferable that the transparent conductive film 5 contains at least one kind of SnO₂ and In₂O₃ as a main component. A thickness of transparent conductive film 5 is preferably equal to 1 to 5 nm. If it is equal to 1 nm or more, a power margin can be widened. If it is equal to 5 nm or less, the excellent recording sensitivity can be obtained.

Subsequently, an example of a manufacturing method of the optical recording medium according to the third embodiment of the invention will be described. Such a manufacturing method of the optical recording medium has a film forming step of the transparent conductive film after the film forming step of the second recording film and before the film forming step of the dielectric film in the foregoing first embodiment.

An example of film forming conditions of the transparent conductive film 5 is shown below.

### (Film Forming Step of Transparent Conductive Film)

The substrate 1 is conveyed into the vacuum chamber in which, for example, a target made of SnO₂ has been set and the inside of the vacuum chamber is evacuated until its pressure becomes a predetermined pressure. After that, while a processing gas is introduced into the vacuum chamber, the target is sputtered and the transparent conductive film 5 is formed onto the second recording film 2b.

Ultimate vacuum degree: 5.0×10⁻⁵ Pa

Atmosphere: 0.1 to 0.6 Pa

Applied electric power: 1 to 3 kW

Gas kind: Ar gas

Flow rate of Ar gas: 24 sccm

As mentioned above, according to the third embodiment of the invention, since tin Sn is added to the second recording film 2b and the transparent conductive film 5 is provided between the inorganic recording film 2 and the dielectric film 3, the recording characteristics such as a power margin and the like and the durability can be improved by about 3 to 5 film layers in total. By properly adjusting the film thickness and the additive, the fundamental recording and reproducing characteristics such as power margin, amplitude of 2T, reflectance, and the like can be optimized in a range from the low linear velocity recording to the high linear velocity recording.

By adjusting the oxygen content and film thickness of the second recording film 2b containing the oxide of germanium Ge, even in the case realizing the high recording sensitivity of the optical recording medium 10 the film thickness of the first recording film 2a containing titanium Ti, and the like, such a situation that the recording power margin is narrowed can be suppressed. In the case of using the oxide of germanium Ge as a recording material, since a recording principle is fundamentally based on the thermal recording, a linear velocity dependency of the recording sensitivity has a certain predetermined rate and a linear velocity dependency of the recording characteristics such as a power margin and the like is small. Therefore, in order to raise the recording sensitivity upon high linear velocity recording, even at the low linear velocity, it is effective to raise the sensitivity. In order to widely assure the power margin in this instance, it is an index to similarly widely assure the power margin even at the low linear velocity in order to improve the whole characteristics.

### EXAMPLES

Although the invention will be specifically explained hereinbelow by Examples, the invention is not limited only by those Examples. In the following Examples, portions corresponding to the foregoing embodiments are designated by the same reference numerals.

The optical recording medium 10 of the embodiment is an optical recording medium designed in correspondence to the optical system of the BD. Specifically speaking, it is an optical recording medium designed in accordance with an optical disc recording and reproducing apparatus using an objective lens of two groups whose numerical aperture is equal to 0.85 and a blue-violet semiconductor laser light source whose wavelength is equal to 405 nm.

In the embodiment, a BD disc inspector (made by Pulstec Industrial Co., Ltd., trade name: ODU-1000) is used as an evaluating apparatus of the optical recording medium. A wavelength of the light source is set to 405.2 nm. A linear velocity upon recording is set to 19.67 m/sec (4-times speed recording: 4×) or 9.83 m/sec (2-times speed recording: 2×). A linear velocity upon reproduction is set to 4.92 m/sec (1-time speed recording: 1×). A channel bit length is set to 74.50 nm (recording density of 25 GB for an optical disc having a diameter of 12 cm). A modulating system is set to 17 PP. A mark length of a 2T mark as a shortest mark is set to 0.149 μm. A mark length of an 8T mark is set to 0.596 μm. A track pitch is set to 0.32 μm.

A jitter measurement is performed by using a time interval analyzer TA720 made through an equalizer board made by Pulstec Industrial Co., Ltd. by Yokogawa Electric Corporation. It is assumed that the equalizer conforms with the standard and the jitter of the signal obtained after it passed through a limit equalizer is measured.

In the measurement of a recording sensitivity Pwo, a power sweep is performed from a low power side to a high power side. A center of recording power values on the over-power side and the under-power side which can be permitted by the system is assumed to be Pwo. There are methods of several regulations with respect to the measurement of the power margin. In the embodiment, a range where the jitter value obtained after the signal passed through the limit equalizer is equal to 8.5% or less is defined as a margin of the recording sensitivity and a value obtained by dividing such a power range by the optimum power is defined as a power margin.

Besides, in the measurement of the amplitude, modulation degree, and the like, a digital oscilloscope TDS7104 made by Tektronix Inc. is used.

The absorption coefficient k in the embodiment is obtained as follows by using the ellipsometer (made by Rudolph Co., Ltd., trade name: Auto EL-462P17). The tangent Ψ which is obtained from the phase angle Δ of the elliptic polarization light and the amplitude-intensity ratio of the ellipse is measured by the ellipsometer. The complex refractive index N and the absorption coefficient k are obtained from the film thickness obtained by the surface profiler (made by Tencor Co., Ltd., trade name: P15). The absorption coefficient k is measured at the wavelength of 410 nm.

### Examples 1-1 to 1-6, Comparison 1-1

In Examples 1-1 to 1-6 and Comparison 1-1, the optical recording media 10 are formed by adding tin Sn to the second recording film 2b made of the oxide of germanium Ge and its characteristics are evaluated.

First, the polycarbonate substrate (hereinbelow, referred to as a PC substrate) 1 having a thickness of 1.1 mm is formed by injection molding. The concave/convex surface 11 having the in-groove Gin and the on-groove Gon is formed on the PC substrate 1. A depth of in-groove Gin is set to 20 nm and a track pitch is set to 0.32 μm.

Subsequently, the TiMnN film 2a having a thickness of 22 nm, the GeOSn film 2b having a thickness of 25 nm, the ZnS—SiO₂ film 3a having a thickness of 52 nm, and the Si₃N₄ film 3b having a thickness of 4 nm are sequentially formed on the PC substrate 1 by using a film forming apparatus (made by Unaxis Co., Ltd., trade name: Sprinter). After that, the surface of the Si₃N₄ film 3b is spin-coated with a UV resin and the UV resin is hardened by irradiating UV light, thereby forming the light transmitting layer 4. A thickness of light transmitting layer 4 is set to 100 μm. In this manner, the target optical recording medium 10 is obtained.

A specific film forming procedure is as follows.

### (Film Forming Step of TiMnN Film)

First, after the inside of the vacuum chamber was evacuated, while an Ar gas and an N₂ gas are introduced into the vacuum chamber, the TiMn target is sputtered and the TiMnN film 2a having the thickness of 22 nm is formed onto the PC substrate 1. A content of manganese Mn in the TiMn target is set to 20 atom %.

Film forming conditions in the film forming step are shown below.

Ultimate vacuum degree: 5.0×10⁻⁵ Pa

Atmosphere: 0.2 Pa

Applied electric power: 3 kW

Flow rate of Ar gas: 30 sccm

Flow rate of N₂ gas: 6 sccm

### (Film Forming Step of GeOSn Film)

Subsequently, after the inside of the vacuum chamber was evacuated, while the Ar gas and an O₂ gas are introduced into the vacuum chamber, the Ge target and the Sn target are cosputtered by reactive sputtering, thereby forming the GeOSn film 2b having the thickness of 25 nm onto the TiMnN film 2a. A content of oxygen O in the GeOSn film 2b is adjusted so that the absorption coefficient k of the GeOSn film 2b is equal to 0.67. As shown in Table 1, compositions of the GeOSn film 2b are adjusted so that a content of tin Sn in the GeOSn film 2b lies within a range from 0 to 13 atom % and a content of GeOₓ (0<x<2) in the GeOSn film 2b lies within a range from 87 to 100 atom %.

Film forming conditions in the film forming step are shown below. In order to form a plurality of samples by changing the content of tin Sn, the film is formed onto the TiMnN film 2a by the cosputtering using three targets. The content of oxygen O is adjusted in accordance with a desired content of tin Sn so that the absorption coefficient measured after the film forming is equal to 0.67.

Ultimate vacuum degree: 5.0×10⁻⁵ Pa

Atmosphere: 0.2 Pa

Applied electric power: 0.4 kW in the case of the Ge targets (two targets), 0.1 to 0.5 kW in the case of the Sn target

Flow rate of Ar gas: 30 sccm

Flow rate of O₂ gas: 30 to 40 sccm

### (Film Forming Step of ZnS—SiO₂ Film)

Subsequently, after the inside of the vacuum chamber was evacuated, while the Ar gas is introduced into the vacuum chamber, the ZnS—SiO₂ target is sputtered, thereby forming the ZnS—SiO₂ film 3a having the thickness of 52 nm onto the GeOSn film 2b. Compositions of the ZnS—SiO 2 film 3a are adjusted so that a composition ratio (atom ratio) (ZnS:SiO₂) of the ZnS—SiO₂ film 3a is equal to (80:20).

Film forming conditions in the film forming step are shown below.

Ultimate vacuum degree: 5.0×10⁻⁵ Pa

Atmosphere: 0.1 Pa

Applied electric power: 1 kW

Flow rate of Ar gas: 6 sccm

### (Film Forming Step of Si₃N₄ Film)

Subsequently, after the inside of the vacuum chamber was evacuated, while the Ar gas and the N₂ processing gas are introduced into the vacuum chamber, the Si target is sputtered, thereby forming the Si₃N₄ film 3b having the thickness of 4 nm onto the ZnS—SiO₂ film 3a.

Ultimate vacuum degree: 5.0×10⁻⁵ Pa

Atmosphere: 0.3 Pa

Applied electric power: 4 kW

Flow rate of Ar gas: 50 sccm

Flow rate of N₂ gas: 37 sccm

### <Evaluation of Jitter>

With respect to the optical recording media 10 obtained as mentioned above, the recording at 4× and the reproduction at 1× are executed under the foregoing conditions and the jitters are obtained. Thus, in any of the contents of tin Sn, the good recording characteristics of a bottom jitter of 6.5% are obtained.

### <Evaluation of Recording Sensitivity and Power Margin>

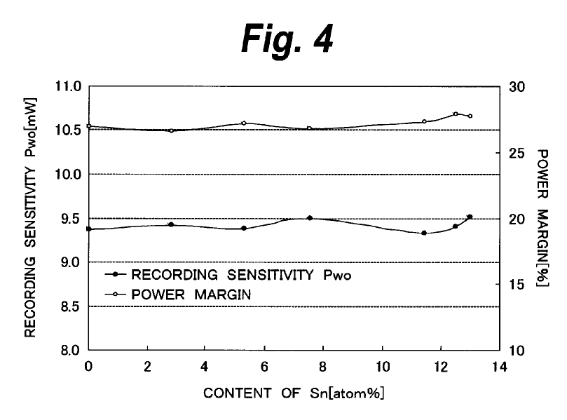

Recording sensitivities Pwo and power margins of the optical recording media 10 are obtained and their results are shown in Table 1 and FIG. 4. It will be understood from Table 1 and FIG. 4 that when the content of tin Sn lies within the range of 0 to 13 atom %, the Sn addition dependency of each of the recording sensitivities Pwo and the power margins is small and the good recording characteristics are obtained.

### <Evaluation of Amplitude Value>

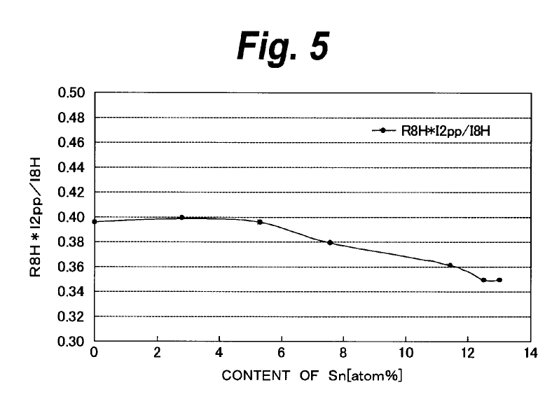

Amplitude values R8H*I2pp/I8H of the 2T signal when the reproduction has been executed are obtained and their results are shown in Table 2 and FIG. 5. The amplitude values R8H*I2pp/I8H show a fluctuation amount of reflectance of the 2T signal defined by the BD-R standard. R8H denotes a reflectance of an 8T space of the RF signal. I2pp denotes a detection voltage value of a 2T amplitude. I8H denotes a detection voltage value of the 8T space. It will be understood from Table 2 and FIG. 5 that as the content of tin Sn increases, the amplitude value R8H*I2pp/I8H decreases and it decreases to about 0.36% as a standard value when the content of tin Sn is equal to 12 atom %. Therefore, the content of Sn in the GeOSn film 2b is preferably equal to 12 atom % or less, much preferably, 10 atom % or less.

### <Evaluation of Durability>

Subsequently, durability tests are executed as follows to the obtained optical recording media 10. First, the optical recording media 10 are held in a thermostat at 80° C. and 85% RH (relative humidity) for 400 hours. After that, a measurement of an SER (Symbol Error Rate) and a microscope observation are executed. Thus, in the optical recording media 10 in which the content of tin Sn is less than 3 atom %, an increase in SER is large and a number of white spots of a size of 10 μm are observed by the microscope observation. In the optical recording media 10 in which the content of tin Sn is equal to 3 atom % or more, no white spots are observed by the microscope observation. The larger the content of tin Sn is, the more the SER decreases. Therefore, the addition of tin Sn is effective for improvement of the durability and its addition amount is preferably equal to 3 atom % or more, much preferably, 5 atom % or more.

According to the above evaluation, from a viewpoint of the improvement of the signal characteristics and the durability, the content of tin Sn is preferably equal to 3 to 12 atom %, much preferably, 3 to 10 atom %, and further preferably, 5 to 10 atom %.

TABLE 1

| | | Recording | |
|---|---|---|---|
| | Content of Sn | sensitivity | Power margin |
| | [atom %] | [mW] | [%] |
| Comparison 1-1 | 0.00 | 9.37 | 27.0 |
| Example 1-1 | 2.80 | 9.42 | 26.6 |
| Example 1-2 | 5.30 | 9.38 | 27.1 |
| Example 1-3 | 7.56 | 9.50 | 26.8 |
| Example 1-4 | 11.44 | 9.33 | 27.3 |
| Example 1-5 | 12.50 | 9.41 | 27.9 |
| Example 1-6 | 13.00 | 9.51 | 27.7 |

TABLE 2

| | | Amplitude |
|---|---|---|
| | Content of Sn | R8H * I2pp/I8H |
| | [atom %] | [%] |
| Comparison 1-1 | 0.00 | 0.40 |
| Example 1-1 | 2.80 | 0.40 |
| Example 1-2 | 5.30 | 0.40 |
| Example 1-3 | 7.56 | 0.38 |
| Example 1-4 | 11.44 | 0.36 |
| Example 1-5 | 12.50 | 0.35 |
| Example 1-6 | 13.00 | 0.35 |

### Examples 2-1 to 2-6

In Examples 2-1 to 2-6, the optical recording media 10 in each of which the transparent conductive film 5 is provided between the inorganic recording film 2 and the dielectric film 3 are formed and their characteristics are evaluated.

The optical recording media 10 are obtained in a manner similar to Example 1-2 except that after the GeOSn film 2b was formed, the SnO₂ film 5 having a thickness of 0 to 5 nm is formed as shown in Table 3 without performing an atmospheric corrosion and the ZnS—SiO₂ film 3a is subsequently formed without performing the atmospheric corrosion.

Specific film forming conditions of the SnO₂ film are as follows.

Ultimate vacuum degree: 5.0×10⁻⁵ Pa

Atmosphere: 0.2 Pa

Applied electric power: 0.4 kW in the case of the SnO₂ target

Flow rate of Ar gas: 10 sccm

The film thickness is adjusted based on the sputtering time.

### <Evaluation of Power Margin>

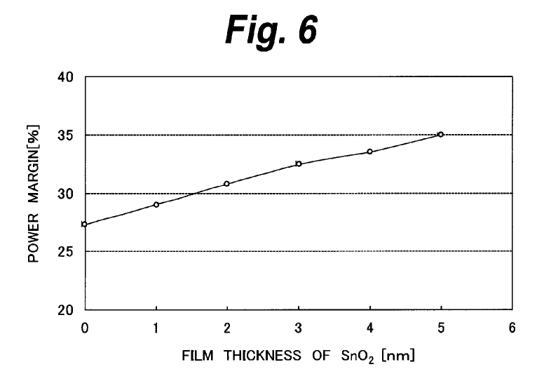

With respect to the optical recording media 10 obtained as mentioned above, the recording at 4× and the reproduction at 1× are executed and the power margins of the optical recording media 10 are obtained and their results are shown in Table 3 and FIG. 6. Thus, it will be understood from Table 3 and FIG. 6 that there is such a tendency that the larger the thickness of SnO₂ film 5 is, the power margin is widened.

### <Evaluation of Recording Sensitivity>

With respect to the optical recording media 10 obtained as mentioned above, the recording at 2× and the reproduction at 1× are executed and the recording sensitivities Pwo of the optical recording media 10 are obtained. Thus, it has been found that when the thickness of SnO₂ film 5 is equal to 5 nm or less, the recording sensitivity of 7 mW of the 2× standard can be satisfied. With respect to the optical recording media 10 in each of which the thickness of SnO₂ film is equal to 6 nm or more, the recording at 2× and the reproduction at 1× are executed and the recording sensitivities Pwo are similarly obtained. Thus, it could been confirmed that when the thickness of SnO₂ film 5 is equal to 6 nm or more, it is difficult to satisfy the recording sensitivity of 7 mW of the 2× standard.

According to the above evaluation results, it is preferable to provide the transparent conductive film 5 between the inorganic recording film 2 and the dielectric film 3 from a viewpoint of the power margin. It is also preferable to provide the transparent conductive film 5 between the inorganic recording film 2 and the dielectric film 3 and to set the thickness of transparent conductive film 5 to a value within a range of 1 to 5 nm from a viewpoint of the power margin and the recording sensitivity.

TABLE 3

| | Film thickness | |
|---|---|---|
| | of SnO₂ | Power margin |
| | [nm] | [%] |
| Example 2-1 | 0 | 27.3 |
| Example 2-2 | 1 | 28.5 |
| Example 2-3 | 2 | 30.8 |
| Example 2-4 | 3 | 32.5 |
| Example 2-5 | 4 | 33.5 |
| Example 2-6 | 5 | 35.0 |

### Examples 3-1 to 3-6

In Examples 3-1 to 3-6, the optical recording media 10 are formed by providing the transparent conductive film 5 between the inorganic recording film 2 and the first dielectric film 3a and by using the SCZ as a dielectric substance of the second dielectric film 3b and their characteristics are evaluated.

The optical recording media 10 are obtained in a manner similar to Examples 2-1 to 2-6 except that after the ZnS—SiO₂ film 3a was formed, the SCZ film 3b having a thickness of 4 nm is formed without performing the atmospheric corrosion.

Specific film forming conditions of the SCZ film 3b are as follows.

Ultimate vacuum degree: 5.0×10⁻⁵ Pa

Atmosphere: 0.2 Pa

Applied electric power: 2.0 kW in the case of the SCZ target

Flow rate of Ar gas: 15 sccm

The film thickness is adjusted based on the sputtering time.

### <Evaluation of Power Margin>

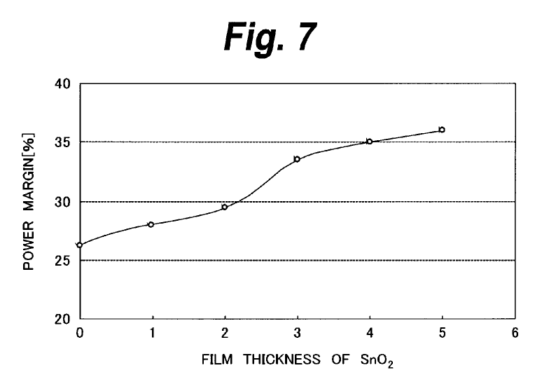

With respect to the optical recording media 10 obtained as mentioned above, the recording at 4× and the reproduction at 1× are executed and the power margins of the optical recording media 10 are obtained and their results are shown in Table 4 and FIG. 7. It will be understood from Table 4 and FIG. 7 that there is such a tendency that the larger the thickness of SnO₂ film 5 is, the power margin is widened. In other words, it will be understood that effects similar to those in Examples 2 are obtained irrespective of the kind of second dielectric film 3b provided under the light transmitting layer 4.

### <Evaluation of Recording Sensitivity>

With respect to the optical recording media 10 obtained as mentioned above, the recording at 2× and the reproduction at 1× are executed and the recording sensitivities Pwo of the optical recording media 10 are obtained. Thus, it has been found that when the thickness of SnO₂ film 5 is equal to 5 nm or less, the recording sensitivity of 7 mW of the 2× standard can be satisfied. With respect to the optical recording media 10 in each of which the thickness of SnO₂ film is equal to 6 nm or more, the recording at 2× and the reproduction at 1× are executed and the recording sensitivities Pwo are similarly obtained. Thus, it could been confirmed that when the thickness of SnO₂ film is equal to 6 nm or more, it is difficult to satisfy the recording sensitivity of 7 mW of the 2× standard.

According to the above evaluation results, it is preferable to provide the transparent conductive film 5 between the inorganic recording film 2 and the dielectric film 3 from a viewpoint of the power margin. It is also preferable to provide the transparent conductive film 5 between the inorganic recording film 2 and the dielectric film 3 and to set the thickness of transparent conductive film 5 to a value within a range of 1 to 5 nm from a viewpoint of the power margin and the recording sensitivity.

TABLE 4

| | Film thickness | |
|---|---|---|
| | of SnO₂ | Power margin |
| | [nm] | [%] |
| Example 3-1 | 0 | 26.2 |
| Example 3-2 | 1 | 28.0 |
| Example 3-3 | 2 | 29.5 |
| Example 3-4 | 3 | 33.5 |
| Example 3-5 | 4 | 35.0 |
| Example 3-6 | 5 | 37.5 |

Although the embodiments and Examples of the invention have specifically been described above, the invention is not limited to the foregoing embodiments and Examples but various modifications based on the technical idea of the invention are possible.

For example, the numerical values mentioned in the foregoing embodiments and Examples are nothing but examples and other numerical values different from them may be used as necessary.

The constructions of the foregoing embodiments and Examples can be mutually combined without departing from the spirit of the invention.

Although the examples in which the invention is applied to the optical recording medium having the inorganic recording film of the single layer have been described in the foregoing embodiments and Examples, the invention can be also applied to an optical recording medium having an inorganic recording film of two or more layers.

Although the case where the invention is applied to the optical recording medium in which the light transmitting layer is provided on the inorganic recording film and the recording or reproduction of the information signal is executed by irradiating the laser beam from the light transmitting layer side to the inorganic recording film has been described as an example in the foregoing embodiments and Examples, the invention is not limited to such an example. For example, the invention can be also applied to: an optical recording medium in which inorganic recording film is provided on the substrate and the recording or reproduction of the information signal is executed by irradiating the laser beam from the substrate side to the inorganic recording film; or an optical recording medium in which two substrates are adhered and the recording or reproduction of the information signal is executed by irradiating the laser beam from one substrate side to the inorganic recording film between the substrates.

It should be understood by those skilled in the art that various modifications, combinations, sub-combinations and alterations may occur depending on design requirements and other factors insofar as they are within the scope of the appended claims or the equivalents thereof.

What is claimed is:

1. An optical recording medium having an inorganic recording film,
wherein said inorganic recording film has:
a first recording film containing titanium Ti; and
a second recording film containing oxides of germanium Ge and tin Sn.

2. The optical recording medium according to claim 1, wherein a content of tin Sn in said second recording film is equal to 3 to 12 atom %.

3. The optical recording medium according to claim 1, further comprising:
a transparent conductive film formed on said second recording film; and
a dielectric film formed on said transparent conductive film.

4. The optical recording medium according to claim 3, wherein said transparent conductive film contains the oxide of tin Sn.

5. The optical recording medium according to claim 3, wherein a thickness of said transparent conductive film is equal to 1 to 5 nm.

6. A manufacturing method of an optical recording medium having an inorganic recording film, comprising the steps of:
forming a first recording film containing titanium Ti; and
forming a second recording film containing oxides of germanium Ge and tin Sn.
